(19) United States
(12) Patent Application Publication
(10) Pub. No.: US 2002/0141289 A1
(43) Pub. Date: Oct. 3, 2002

(54) WATCH COMPRISING AN ELECTRONIC TOURIST GUIDE

(76) Inventors: GEORGES NICOLAS HAYEK, ZURICH (CH); JACQUES MULLER, RECONVILIER (CH)

Correspondence Address: GRIFFIN BUTLER WHISENHUNT & SZIPL LLP, SUITE PH-1, 2300 NINTH STREET SOUTH, ARLINGTON, VA, 222042396

(21) Appl. No.: 09/406,106

(22) Filed: Sep. 27, 1999

(30) Foreign Application Priority Data
Sep. 28, 1998 (CH) 1971/98

(51) Int. Cl. G04C 11/02

(52) U.S. Cl. 368/47

(57) ABSTRACT

This watch can guide its wearer towards a place specified by the wearer and comprises time display means (2, 3, 11), selection means (9), data processing means (8) and means for determining the direction of the said place, formed by an antenna (5) and a GPS receiver (6) for determining the geographical coordinates of the location where the said watch is situated. According to the invention this watch further comprises an electronic tourist guide comprising a re-programmable memory unit (14) arranged to receive a database relative to local tourist information, the said selection means (9) being so arranged that the wearer can select the said place in the said database, and that the said means for determining the direction can determine the said direction of the said place and can then indicate this direction by way of the said display means (2, 3, 11).

The present invention relates to an electronic tourist guide comprising a GPS (Global Positioning System) receiver for guiding its wearer towards a place or establishment selected by him.

A tourist who arrives in an unknown town is often restricted in his freedom for lack of an adequate tourist guide. Thus he can consult the local tourist office, which can provide information relating to the town, such as a list of museums, restaurants, a rough plan of the town, etc., but which clearly cannot escort the tourist to the selected places. Moreover the availability of the employees of a tourist office is not always the best, especially in the high season for tourism, and the information given is not exhaustive, especially in relation to establishments which are not typically touristic (shops, restaurants, etc.).

Devices for aiding driving are moreover known, such as navigation systems comprising a GPS receiver combined with a CD-ROM reader or an electronic card reader, etc. A CD-ROM containing a map of the country and/or town plans can be inserted as required and a town or a road can be programmed as a destination. The GPS receiver receives a high frequency signal coming from several satellites and containing position data, through an antenna to which the receiver is connected. The position of the car can then be detected by means of the GPS signals, so it is possible to display the direction to follow to arrive at a destination.

In order to alleviate this latter limitation in part a mobile tourist information process has been proposed in the document FR-A 2 730 083. This process envisages use of a GPS receiver in combination with a compact disc (CD) reader. The CD reader can be integrated in a car radio device. This process further presumes the existence of compact discs containing local tourist data. Thus the user can insert an appropriate compact disc and indicate a circular perimeter whose distance from the centre is determined by the user. A processing unit detects the position of the user by means of the GPS signals and displays the places close to which it passes within this perimeter. This process thus prompts the user to visit a destination which he would not have previously envisaged.

However, this process does not provide the possibility of selecting a specific destination beforehand. It is thus not possible to select a museum for example and have the direction to the museum displayed. Moreover, the devices mentioned above require a CD reader as a data carrier, so making them bulky and expensive. Moreover, the processing system for this data has to have high performance and is thus electrically power-hungry.

The object of the present invention is to overcome the problems referred to above and provide a compact and flexible electronic tourist guide, which is integrated in a watch comprising a GPS receiver and means allowing the user to select his own destinations among a plurality of suggested destinations, the watch moreover having means for indicating a direction.

Another object of the present invention is to provide such a watch with low consumption and which is relatively inexpensive.

These objects as well as others are met through the characteristics exhibited by the watch according to claim 1.

One embodiment of the subject matter of the present invention will now be described, solely by way of example, with reference to the accompanying drawings, in which:

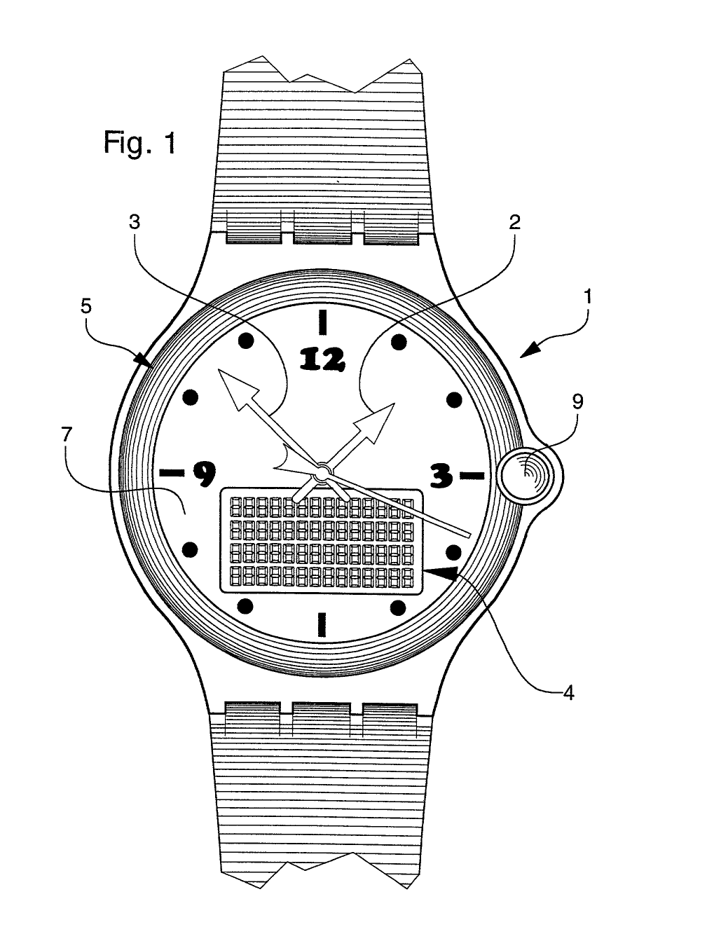

FIG. 1 is a plan view of a preferred embodiment of a watch according to the invention,

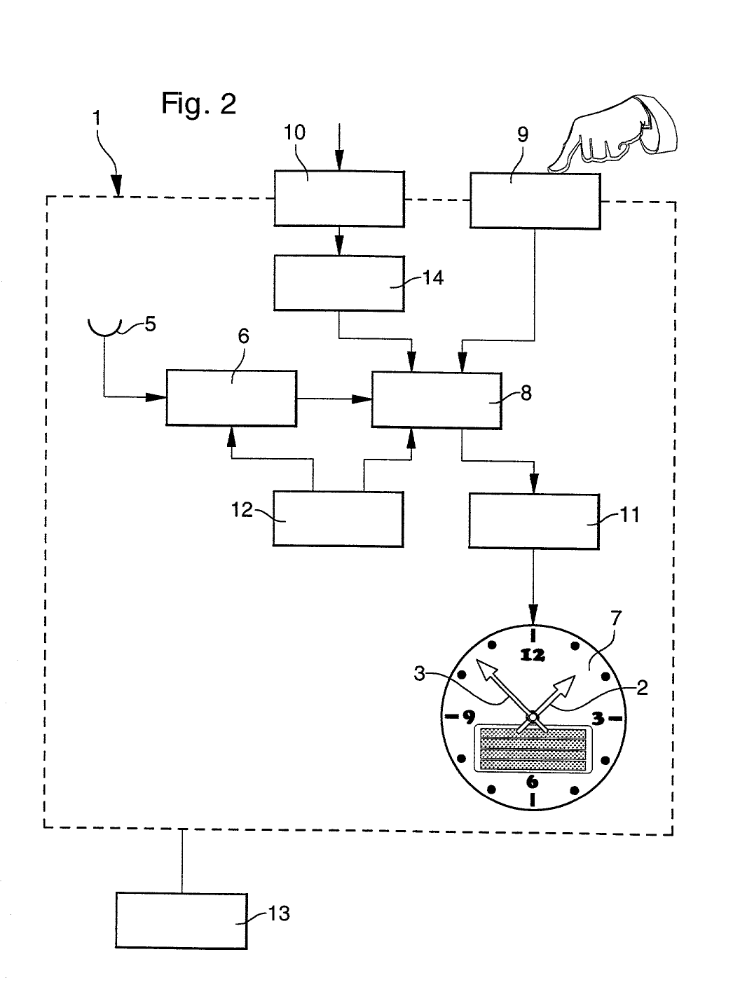

FIG. 2 shows a block functional diagram of the internal structure of the watch according to the present invention,

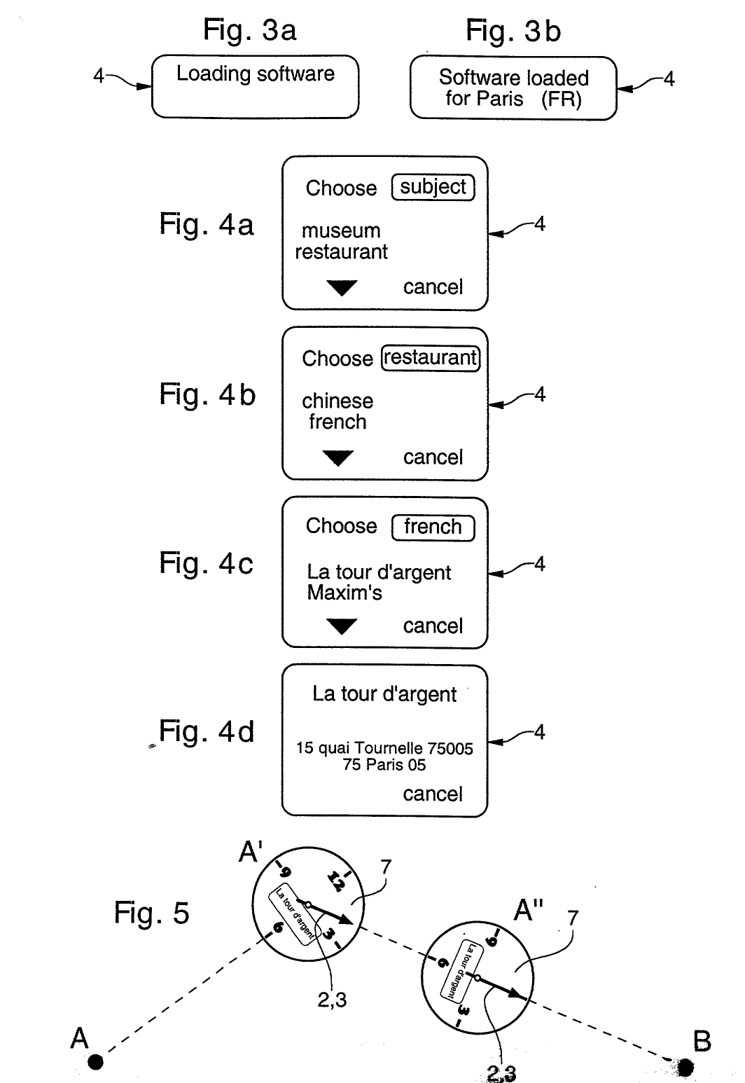

FIG. 3 is an enlarged representation of the digital display cell of the watch of FIG. 1,

FIGS. 4a to 4d represent the different stages to follow on the display of FIG. 3 to make a selection of a tourist site, and

FIG. 5 represents the watch of FIG. 1 functioning as a tourist guide.

FIG. 1 shows a preferred embodiment of a multifunction watch comprising an electronic tourist guide according to the invention. The multifunction watch 1 comprises a timepiece which displays the time of day by means of means for displaying the hour, here hour and minute hands 2 and 3 respectively, a dial 7 as well as a display cell 4, formed by a liquid crystal display for example which can display the day and date or other information, according to the function selected. The watch 1 further comprises means for determining direction formed by an antenna 5 associated with a GPS receiver 6 (see FIG. 2). The antenna 5 is formed so that it can receive signals transmitted by one or more satellites and can advantageously form a part or the whole of the dial 7.

Referring to FIG. 2, the output of the GPS receiver 6 is connected to a first input of data processing means 8, typically a microprocessor. The processing means 8 have a second input, associated with a re-programmable memory unit 14 whose input is connected to the output of means 10 for entering data, a third input connected to the output of selection means 9 adapted to be operated by the user of the watch 1, and an output connected to an input of a motor 11 connected to the hands 2 and 3 and arranged to drive the latter. A fourth input of the processing means 8 is connected to the timepiece or internal clock 12, typically a timebase associated with a quartz crystal. Obviously the watch further comprises a power supply 13 such as a battery or a micro-generator associated with an oscillating mass.

The selection means 9 can be formed by a conventional push-button arranged to be capable of selecting different functions and effecting the time setting of the watch 1. For example, these selection means 9 are realised in the form of a ball control device such as is described in the document EP-A 0 582 150. The data input means 10 serve to provide the information necessary for the electronic tourist guide to the data processing means 8, by way of the re-programmable memory unit 14.

The re-programmable memory unit 14 may be formed by a volatile memory (a RAM for example) or a non-volatile re-programmable memory (an EEPROM for example) and it is arranged to receive software through the data input means 10. The software contains a database relating to the local and/or regional tourist information as well as an application program dedicated to the processing of this local and/or regional tourist data. The reprogrammable memory unit 14 preferably contains a program operating by menu, allowing the wearer of the watch 1 to select, by way of the selection means 9, a specific tourist site in the tourist database, as will be explained in detail below.

Obviously it is equally possible for the application program and/or the program operating by menu to be already present in the watch, for example in a non-volatile memory pre-programmed to this end. Thus only the database has to be loaded for a given locality or region. The man skilled in the art knows how to load the software in a suitable manner into the watch. One way of loading software is described for example in the document U.S. Pat. No. 4,853,682. This document describes a watch having a transmitter-receiver which can transmit data between a watch and a computer. The watch and the computer each contain a coil associated with an electronic transmission circuit allowing communication between the two units. The coil thus functions as the data input means. Other transmissions of data without contact can equally be envisage, in particular by light or ultrasonic signals.

In one particularly advantageous mode, the watch 1 has a rechargeable power supply 13. In order to charge the supply 13, the watch generally has to be placed in a charging device (not shown). As the charging device conventionally contains a coil for transmitting electromagnetic power to the power supply 13 of the watch 1, it is also possible to transmit data at the same time, for example by modulating the charging electromagnetic field. The transmission of the software takes place in this case through the charging device for this supply. An example showing this way of transmitting data from an external device to the watch is given in more detail in the document NL-A 90 00685, which describes a portable and rechargeable device which can receive information during the inductive charging, when this device is placed in its charger.

When the database of the loaded software contains only the tourist data of a specific town or region, the time for loading is limited and it is possible to avoid loading and thus storing too much information. Thus, all the information can be stored in the re-programmable memory unit 14 and there is no need to provide a CD reader or other external apparatuses for storing data which are bulky and power-hungry.

To this end, when the wearer of the watch 1 according to the invention arrives in a town or a region which he wishes to visit, the software with at least a tourist database of this town or region is loaded in the watch, preferably by means for entering data without contact. This can be effected at the local tourist office but also at a specially adapted site, such as a shop or a kiosk. It is even possible to envisage providing electronic apparatus of automatic teller type, similar to those known by the name “BancomatAE” allowing the watch 1 to be loaded automatically.

In order to facilitate use, the numerical display 4 of the watch 1 can indicate for example the state and the mode of operation thereof. By manipulating the selection means 9 it is possible to select the mode “load” so that the software containing the local tourist database can be loaded into the watch 1. FIG. 3a shows an example of the indication on the display 4 when the watch is in course of being loaded (“loading software”). FIG. 3b shows the end of loading and the display 4 thus indicates that the software containing the tourist data has been loaded. In the example which will be described below, the tourist is in Paris, France.

Once the software has been loaded, the wearer of the watch 1 according to the invention can use the program for operation by menu to make his selection. FIGS. 4a to 4d show an example of a menu having a tree structure.

In FIG. 4a there is seen a first menu giving several subjects for choice: museums (“museum”), restaurants (“restaurant”), cabarets, etc. Obviously the number of subjects only depends on the loaded software. The interface for presenting these menus can be realised in a manner known for example in GSM mobile cell-phones (Global System for Mobile communication). Thus, the selection means 9 can be manipulated to run through all the list of subjects. When a subject suits the wearer of the watch 1, he can confirm his choice by pressing the selection means 9. Once the selection is effected, for example “restaurant”, this is indicated, see FIG. 4b, and a sub-menu is presented. This sub-menu can in particular comprise a list of different categories of restaurants, for example Chinese, (“chinese”), French (“french”), etc. The wearer then selects the category, in this example French cuisine, and a list of restaurants providing a French cuisine is displayed, see FIG. 4c. The wearer then selects a restaurant which suits him, see FIG. 4d. If the wearer of the watch 1 makes a mistake, he can always return to the preceding (sub-) menu, by selecting for example the cancel option (“cancel”).

When the selection is confirmed, for example by pressing the selection means 9 again, the name of the restaurant is displayed and the data processing means 8 search in a pre-programmed table of the database loaded with the geographical coordinates, i.e. the longitude, the latitude and possibly the altitude, corresponding to the restaurant selected by the user. The operation of the electronic tourist guide incorporated in the watch 1 to direct its user is described below with the aid of FIG. 5.

The wearer is located initially at a point A, for example the tourist office, having the geographical coordinates (A1, A2, A3), and wants to visit the subject located at point B, which has the geographical coordinates (B1, B2, B3). The wearer selects and starts the “direction” mode of operation by the selection means 9 serving also as control means. The wearer has to wait to be located by the necessary number of satellites, generally at least three satellites, by means of the GPS receiver 6, in order to obtain the coordinates (A1, A2, A3). The GPS receiver advantageously stores the access codes to the said satellites, to allow it to receive information later, without having to wait to be located again. More particularly, the GPS receiver 6 receives the geographical coordinates and time from at least three satellites and, through a calculation algorithm known for example from the document “Radio-navigation systems” of Bˆ rje Forssell, it deduces the position of the wearer of the watch 1 represented by the triplet of geographical coordinates (A1, A2, A3). However, the orientation of the watch 1 is not known. Thus the wearer starts to walk in any direction whatsoever, towards a point A′ for example, for which the triplet of geographical coordinates (A′1. A′2, A′3) of this point A′ can be determined by the GPS receiver 6. Thus a reference direction can be determined, which is aligned with a reference axis of the watch. This reference axis can be defined in the manner described in the European patent application EP 0 871 096, which is incorporated herein by reference. Moreover, this patent application shows the possibility of using the hands of the watch as indicators for the sense to walk and/or the direction to be followed to reach the selected destination. In the example described, the assembly formed by the hands 2 and 3 can be shifted under the combined action of data processing means and a motor controlled thereby; see for example European patent application EP 0 721 155.

Obviously it is possible in another embodiment to provide a compass in the watch 1 in order to obtain a reference to magnetic north, so as to establish the orientation directly. However, this increases the size of the watch.

According to European patent application EP 0 871 096 cited above, the 6h-12h axis of the dial 7 of the watch 1 can be used as the reference axis. The wearer of the watch aligns this axis with the direction in which he is walking, i.e. the direction between the points A and A′, in order to determine a reference orientation.

In the example described in this patent application, after determining the direction along this reference axis, the hands are then shifted under the combined action of the processing means 8 and the motor 11 to indicate the direction in which the wearer of the watch according to the invention should walk relative to the reference axis to reach the destination, i.e. the direction between the point A′ and the point B. Thus, if the wearer always uses the axis 6h-12h of the dial as the reference axis and aligns this with the direction in which he is walking, he is directed towards the destination, i.e. the chosen restaurant, when the assembly formed by the hands 2 and 3 is aligned with this axis 6h-12h, as is shown in FIG. 5 at the point A″.

Obviously it is also possible to provide other points of reference and/or reference axes, for example a circular row of diodes around the bezel or the dial which light up to indicate the direction.

In the positioning system without a compass, the wearer has to walk some distance, which depends on the resolution of the positioning system. By way of example, for the standard GPS, this distance is a minimum of around 30 meters, while for the dGPS system (for differential GPS), this distance can be reduced to a few meters. Obviously, when the watch includes a compass, the walking direction is not important, because the direction to be followed can be indicated relative to magnetic north at any time, the latter direction being determined continuously or with a given frequency.

Thus the wearer of the watch can easily locate himself in an unknown town and is free to move around where and when he wishes, thanks to the watch incorporation an electronic tourist guide according to the invention. Moreover, this electronic tourist guide only occupies a small space and is relatively little power-hungry.

It should be observed that several modifications and/or improvements can be made to the watch according to the invention, without departing from the scope thereof.

For example, the watch according to the invention could be modified in such a way that one of the two hands indicate the direction of the selected destination, while the other hand indicates for example the direction of geographical north, or the time. A digital display can also be provided in place of an analog display to indicate the direction to follow.

Finally, in a preferred variant, provision is made to indicate the distance to be covered and/or the remaining distance to the selected destination, so that the user can decide if the distance to cover or remaining to this destination is acceptable to him.

What is claimed is

1. A multifunction watch for guiding its wearer towards a place or an establishment specified by the wearer, and comprising an internal clock, display means in particular for the time, selection means for selecting functions, data processing means, a power supply, means for entering data, and means for determining the direction to the said place or establishment which are associated with the said processing means and are formed by an antenna and a GPS receiver for determining the geographical coordinates of the location of the said watch, this watch further comprising an electronic tourist guide comprising a re-programmable memory unit arranged to receive software containing at least a database relative to local or regional tourist information, by way of the said means for entering data, the said selection means being so arranged that the wearer can select the said place or establishment in the said database, the said re-programmable memory unit being associated with the said processing means to provide them with the geographical coordinates of the said place or establishment, in such a way that the said means for determining the direction can determine the said direction to the said place or establishment and can then indicate this direction by way of the said display means.

2. A watch according to claim 1, wherein said means for entering data form a unit without external contact, in particular a receiver for electromagnetic signals.

3. A watch according to claim 1, wherein said display means comprise a digital display arranged to display the said data relating to the tourist information.

4. A watch according to claim 1, wherein said software further comprises an application program dedicated to processing the said data.

5. A watch according to claim 1, wherein said power supply is a rechargeable supply, and in which the said software is loaded into the said re-programmable memory unit simultaneously with recharging the said supply.

6. A watch according to claim 1, comprising hands for displaying time data, one of the said hands being used for indicating the direction to the said place or establishment.

7. A watch according to claim 1, further comprising a compass for determining the direction of geographical north.

8. A watch according to claim 1, comprising means for indicating the distance separating the wearer of this watch from a selected destination.

9. A watch according to claim 3, comprising hands for displaying time data, one of the said hands being used for indicating the direction to the said place or establishment.

10. A watch according to claim 6, comprising means for indicating the distance separating the wearer of this watch from a selected destination.
